(19) United States
(12) Patent Application Publication
(10) Pub. No.: US 2020/0269340 A1
(43) Pub. Date: Aug. 27, 2020

(54) Active Laser Vision Robust Weld Tracking System and Weld Position Detection Method

(71) Applicant: TONGGAO ADVANCED MANUFACTURING TECHNOLOGY CO., LTD., Suzhou (CN)

(72) Inventors: Xudong TANG, Suzhou (CN); Ailong JIN, Suzhou (CN); Yajuan JIN, Suzhou (CN); Xuanjun PAN, Suzhou (CN)

(21) Appl. No.: 16/646,556

(22) PCT Filed: Jul. 23, 2019
(86) PCT No.: PCT/CN2019/097168

§ 371 Date: Mar. 11, 2020

(30) Foreign Application Priority Data
Jul. 25, 2018 (CN) 201810826086.1

(51) Int. Cl. B23K 9/127; B25J 9/16; B25J 19/02; B25J 15/00; B23K 9/095; B23K 9/133; G06K 9/00; G06T 7/00; G06T 5/20; G06T 7/13; G06T 5/00; G06T 7/73

(52) U.S. Cl. CPC B23K 9/1274; G06T 2207/30108; B25J 9/1697; B25J 19/022; B25J 19/023; B25J 15/0019; B25J 9/1664; B23K 9/0956; B23K 9/133; G06K 9/00664; G06T 7/0004; G06T 5/20; G06T 7/13; G06T 5/002; G06T 7/73; B25J 9/1684

(57) ABSTRACT

An active laser vision robust weld tracking system, a weld position detection method, and a robust weld tracking algorithm are disclosed in the present invention. The active laser vision robust weld tracking system comprises a laser source, a laser vision sensor, an image processing system, an industrial robot, and an electrical control system. A laser stripe associated with weld profile information is recognized by the laser vision sensor through projecting structured light onto the surface of a weld, the weld feature information is extracted using an image processing method, the position of the weld is detected from the central line of the laser stripe, and then the intelligent tracking of the weld is achieved with a variety of control methods.

### TECHNICAL FIELD

The present invention relates to the technical field of laser welding, and in particular to an active laser vision robust automatic weld tracking system for laser-arc hybrid welding, and to an image processing and weld position detection method.

### BACKGROUND

With the increasingly widespread application of laser welding in industrial production, the limitations of the laser welding technology become increasingly prominent. The main limitations are as follows: the low energy utilization rate of laser welding and the increased welding thickness lead to an increased production cost; laser welding requires high weldment precision for workpieces and has a poor groove bridging capability; laser welds can easily result in undercut, concave and porosity defects due to the intense vaporization of metal, which are difficult to be eliminated by adjusting technological parameters; and as the cooling rate of laser welding is too high, a brittle phase can be easily formed at the weld, thereby resulting in a joint of low plasticity and flexibility. Therefore, laser-arc hybrid welding, which combines laser welding and arc welding to realize high-quality and efficient welding production, has attracted extensive attention. Compared with conventional arc welding and laser welding, laser-arc hybrid welding has advantages such as large welding penetration, high process stability, high welding efficiency, strong welding gap bridging capability and small welding deformation, and can greatly improve welding efficiency and welding quality. However, as this welding method combines laser welding and conventional arc welding, there are many factors affecting the welding process, and the welding process is relatively complex. The weld formation of a welded joint is closely related to weld quality. Only good weld formation can bring excellent mechanical properties for joints, and thus the effective control of weld formation is particularly important.

Laser-arc hybrid welding robots have advantages such as high degree of automation and pliability, good flexibility and stability and fast and accurate actions of industrial robots. There are two important ways to implement the automatic welding: one is a control method based on jogging teaching and playback or off-line programming, and the other is a control method based on an automatic weld tracking technology. Jogging teaching and playback or off-line programming requires that a weld cannot be changed once a spatial trajectory is determined, however, factors such as machining errors in workpiece welding, position errors in positioning and clamping, and thermal deformation of workpieces during welding may lead to a certain degree of change in the weld trajectory, and thus cause a robot welding trajectory obtained by teaching programming to deviate from the actual weld trajectory, thereby weakening the welding quality. An automatic weld tracking system detects, via a sensor, positions of weld feature points (the feature points are discrete points of the actual weld trajectory) in real time, and controls the robot to perform automatic tracking and welding according to the three-dimensional coordinates of the feature points. The automatic weld tracking system has higher flexibility and a wider application range, and can support high-degree automatic welding. An optical vision sensor uses a CCD or CMOS photosensitive chip to directly image a weld, and then acquires the shape, position and other information of the weld from the image. An active optical vision sensor uses a special auxiliary light source to illuminate the local position of a target, and the illuminated position forms a high-brightness region in the image, thus reducing the difficulty for feature extraction. However, it is susceptible to interferences of arc light and spattering. The smaller the distance between the measuring point and the welding point, the stronger the noise of arc light and spattering. These interferences to the vision system contribute to the difficulty of the weld tracking system. Therefore, it has become an urgent problem to be solved in optimizing and improving the automatic weld tracking system to increase the measuring precision, frequency and anti-interference capability of the system by intensifying the robustness of the vision system, effectively extracting weld feature points and resisting arc light and spattering interferences and image noise to some extent. In addition, in the process of manual teaching of the robot, various factors may lead to deviations of an extracted weld feature point trajectory, thus causing problems in welding quality. Therefore, it is also an urgent problem to be solved by the automatic weld tracking system to achieve accurate weld tracking to ensure that a robot tool-side TCP can travel along reliable weld feature points and dynamically and accurately compensate deviations.

### SUMMARY

Object of the invention: the object of the present invention is to provide an intelligent weld tracking system based on active laser vision, an innovative robust weld tracking system and a method for image processing and weld position detection, to solve the problems existing in the prior art. The present invention can combines the weld image recognition with the robot motion control to achieve the automatic extraction and the accurate intelligent tracking of a weld feature, thereby avoiding the issue that a weld tracking system produces too much image noise and thus affects welding quality, welding precision and welding efficiency due to interferences from arc light and spattering during a conventional laser-arc hybrid welding, and avoiding the issue of robot tracking failure resulting from the deviation of a weld feature point trajectory in the process of teaching.

Technical solution: An active laser vision robust weld tracking system comprises: an industrial robot comprising a base, a robotic arm, and a driving mechanism, wherein the robotic arm comprises a lower arm and a forearm, the base is provided with a mount for mounting the lower arm, a lower portion of the lower arm is movably connected to the mount, the forearm is mounted on the top of the lower arm via a movable connection, and the forearm of the industrial robot is provided with a laser-arc hybrid welding joint having a wire-feeding mechanism provided on one side thereof; an active laser vision system comprising a laser source, a laser vision sensor for recognizing a laser stripe, and an image processing system for extracting weld feature information and detecting the position of a weld, wherein the image processing system is electrically connected to the laser vision sensor; and an electrical control system comprising a robot controller configured to control the actions of the industrial robot and the robotic arm thereof, wherein there is a two-way communication connection between the image processing system and the robot controller.

Further, the image processing system comprises a first central processing unit, a first internal storage unit, a vision sensor interface, and a first communication interface, and the laser vision sensor is in two-way communication with each unit in the image processing system via the vision sensor interface.

Further, the robot controller comprises a second central processing unit, a second internal storage unit, a second communication interface, a driver, a motion control card, and an input/output interface, the input/output interface is configured to input and output instructions, the driver is connected to a motor of the robotic arm, and the motion control card is connected to an encoder of the robotic arm.

Preferably, an industrial camera is adopted as the laser vision sensor.

A weld position detection method based on the active laser vision robust weld tracking system described above comprises the following steps:

step 1, recognizing, by the laser vision sensor, a laser stripe associated with weld profile information through projecting structured light onto the surface of a weld;

step 2, extracting weld feature information by using an image processing method, and detecting the position of the weld from the central line of the laser stripe;

step 3, performing the intelligent tracking on the weld, and determining whether a weld tracking path of the industrial robot is precise;

and step 4, controlling a welding operation of the robot according to an intelligent weld tracking result.

Further, the step 2 specifically comprises the following contents:

2.1, image preprocessing:

a, performing mean filtering on a laser stripe image acquired by the laser vision sensor:

$$F ( i , j ) = \frac{1}{L {W}^{2}} {\sum }_{i}^{L W} {\sum }_{j}^{L W} I ( i , j )$$

wherein, LW is a desired laser stripe width, I(i,j) is an image intensity of a pixel in the i-th row and the j-th column, and F(i,j) is a result value of filtering for the pixel in the i-th row and the j-th column;

b, converting the processed image from a RGB color space into an HSV color space, namely, precisely extracting blue laser color from the image, setting thresholds for hue, saturation and value channels, and applying masking to the image, wherein the setting of the three thresholds allows the subsequent processing for a low-contrast laser stripe generated from low-quality laser:

$${M}_{1} = \{ \begin{matrix}1 & H ( i , j ) < 0.1 \\ 1 & H ( i , j ) > 0.9 \\ 0 & otherwise\end{matrix} \\ {M}_{2} = \{ \begin{matrix}1 & S ( i , j ) > 0.2 \\ 0 & otherwise\end{matrix} \\ {M}_{3} = \{ \begin{matrix}1 & V ( i , j ) > 0.2 \\ 0 & otherwise\end{matrix} \\ M = {M}_{1} ⋂ {M}_{2} ⋂ {M}_{3}$$

wherein, M₁, M₂ and M₃ are masking thresholds respectively for the hue, saturation and value channels, i and j are respectively the row number and the column number of a pixel, and M represents a masked intersection region ultimately obtained;

c, converting the original RGB image into a greyscale image by greyscale processing:

Grey=0.299*R+0.587*G+0.114*B

wherein R, G and B in the original RGB (R, G, B) are replaced with Greys to form a new color RGB (Grey, Grey, Grey), thereby forming a single-channel greyscale image that replaces the RGB (R, G, B) image, and the masked intersection is applied to this single-channel greyscale image;

d, performing median filtering on the image to remove salt and pepper noise and speckle noise, wherein a sliding window containing odd points is used in the median filtering to rank the pixels in neighborhood according to grey scales, and the median is taken as an output pixel;

2.2, detection of laser stripe profile:

a, extracting profile edge pixels characterizing the laser stripe by a laser peak detection method, wherein the laser stripe is made vertical, an intensity threshold for accepting or rejecting a pixel is set for each horizontal row, and intensity peak points are obtained to form a laser stripe foundation;

b, performing noise filtering on the pixel intensity peak points generated in a horizontal direction, and fitting the acquired pixel intensity peak points to obtain the baseline position of the laser stripe;

2.3, extraction of weld feature points:

a, determining a ROI in a vertical direction:

$$ROI ( i , c ) = I ( i , j ) with$$

$$p - \frac{LW}{2} \leq j \leq p + \frac{LW}{2} ;$$

$$0 \leq i \leq N$$

wherein, LW is a desired laser stripe width, N is the number of rows for the image, I(i,j) is an image intensity in the i-th row and the j-th column, ROI(i,c) is a region of interest in the image, and P is the column number of a laser line detected in the original image;

and wherein the upper top feature points and lower bottom feature points of the deformed region of the extracted laser line are acquired;

b, marking and selecting an intersection;

c, determining a ROI in a horizontal direction:

ROI(c,j)=I′(i,j)

with Yₜₒₚ≤i≤Y_{bottom}; min(Xₜₒₚ, X_{bottom})≤j≤M

wherein, Yₜₒₚ, Xₜₒₚ, Y_{bottom} and X_{bottom} are coordinate values of the upper top point and the lower bottom point in the intersection set in the image I(i,j) on the y axis and the x axis, and M is the number of columns for the image I(i,j);

and d, acquiring a horizontal peak feature point of the weld.

The weld position detection method is characterized in that acquiring a horizontal peak feature point of the weld specifically comprises the following contents:

d1, removing noise points, and extracting profile points on the laser stripe in the horizontal ROI, i.e. the feature points of the deformed region of the extracted laser stripe profile;

d2, dividing the profile of the laser stripe in the ROI into an upper region and a lower region, and adding additional points for continuity to discontinuities in the deformed region of the laser stripe profile respectively for portions within the upper region and the lower region but outside the profile according to the following constraint condition;

−LW≤P_{ci}≤LW

wherein, LW is a desired laser stripe width, and P_{ci} is the column number of an added discontinuity;

d3, linearly fitting the profile points on the upper and lower laser stripe in the whole ROI mentioned above and the point set consisted of added discontinuities, and the intersection point of the two obtained straight lines being a weld peak feature point.

The weld position detection method is characterized in that in the step 3, when it is determined that the weld tracking path of the industrial robot is precise:

1.1, the robot controller sends a HOME position signal, and the industrial robot searches a start point;

1.2, the robot controller searches the start point of a robot tool-side TCP;

1.3, a first register queue is created to record a laser vision sensor position sequence corresponding to weld feature points;

1.4, it is determined whether the robot tool-side TCP is located at an initial weld feature point, if not, it returns to steps 1.2 to 1.3 to search the start point of the robot tool-side TCP again; and if so, a signal indicating that the robot tool-side TCP is located at the start position of the weld path is sent, and the robot controller starts an instruction for welding operation;

1.5, then the robot controller starts an instruction for weld tracking operation;

1.6, the first register queue continues to be created to record the laser vision sensor position sequence corresponding to the weld feature points;

1.7, the robot tool-side TCP performs the weld feature point tracking operation;

1.8, it is determined whether the robot tool-side TCP is located at the last weld feature point, if not, then it returns to steps 1.6 to 1.7 to recreate a first register queue; and if so, a signal indicating that the robot tool-side TCP is located at the last position of the weld path is sent;

1.9, the robot controller ends an instruction for welding operation.

The weld position detection method is characterized in that in the step 3, when a deviation is found in the weld tracking path of the industrial robot, the deviation of the weld feature point trajectory is compensated, so that the robot tool-side TCP can run along a relatively precise path generated by weld feature points until a laser welding operation is completed. The specific steps are as follows:

2.1, the robot controller sends a HOME position signal, and the industrial robot searches a start point;

2.2, the robot controller searches the start point of a robot tool-side TCP;

2.3, a first register queue is created to record a laser vision sensor position sequence corresponding to weld feature points;

2.4, it is determined whether the robot tool-side TCP is located at an initial weld feature point, if not, it returns to steps 2.2 to 2.3 to search the start point of the robot tool-side TCP again; and if so, a signal indicating that the robot tool-side TCP is located at the start position of the weld path is sent;

2.5, the robot controller determines whether the industrial robot is dry-running;

2.6, if the industrial robot is not dry-running, then the robot controller commands the industrial robot to continuously create the first register queue to record the laser vision sensor position sequence corresponding to the weld feature points;

2.7, a signal indicating that the robot tool-side TCP is located at the last position of the welding path is sent;

2.8, the robot controller ends an instruction for welding operation;

2.9, if the industrial robot is dry-running, then the robot controller commands the industrial robot to create a second register queue to record the vision sensor position sequence corresponding to the weld feature points;

2.10, the robot controller determines whether the industrial robot has completed W dry runs, and if the monitored result shows that it is not completed, then steps 2.1 to 2.9 are repeated;

2.11, if the industrial robot has completed W dry runs, then the optimal estimation for the weld feature points obtained from the W dry runs and a corresponding laser vision sensor position sequence are calculated;

2.12, the robot controller commands the industrial robot to start a welding operation;

2.13, after receiving an instruction for welding operation, the industrial robot starts a welding operation;

2.14, the robot controller starts an instruction for weld tracking operation;

2.15, the robot tool-side TCP performs a tracking operation with reference to the optimal estimation for weld feature points;

2.16, the robot controller determines whether the robot tool-side TCP is located at the last weld feature point, if not, then it returns to steps 2.6 to 2.7 to recreate a first register queue; and if so, a signal indicating that the robot tool-side TCP is located at the last position of the weld path is sent;

2.17, the robot controller ends an instruction for welding operation.

Compared with the prior art, the present invention has made the following notable progress: 1, The present invention can combines the weld image recognition with the robot motion control to achieve the automatic extraction and the accurate intelligent tracking of a weld feature, thereby efficiently avoiding the issue that a weld tracking system produces too much image noise and thus affects welding quality, welding precision and welding efficiency due to interferences from arc light and spattering during a conventional laser-arc hybrid welding, and avoiding the issue of robot tracking failure resulting from the deviation of a weld feature point trajectory in the process of teaching. 2, By using the deformation-free laser stripe baseline detection and weld feature point extraction method, weld feature points can be effectively extracted, and arc light and spattering interferences and image noise can be resisted to a certain degree, thereby increasing the measuring precision, frequency and anti-interference capability of the system, and thus an optimized and improved automatic weld tracking system is obtained. When the path of the industrial robot is found to be imprecise in the process of weld tracking, i.e. having a deviation, the implementation of the method for compensating the deviation of the weld feature point trajectory can dynamically and accurately compensates the deviation, ensures that the robot tool-side TCP travels along reliable weld feature points, and enables a precise weld tracking, further increasing the precision of weld tracking and improving the quality of welding.

### BRIEF DESCRIPTION OF THE DRAWINGS

FIG. 1 is a structural schematic diagram of a laser-arc hybrid welding robot of the present invention;

FIG. 2 is a schematic diagram for the weld feature point extraction in the present invention;

FIG. 3 is a flow chart for a process of weld image processing and weld feature point detection and extraction in the present invention;

FIG. 4 is a main control structure of a weld tracking system guided by active laser vision for the laser-arc hybrid welding of the robot;

FIG. 5 is a schematic diagram of a relative position and pose network in the present invention;

FIG. 6 is a schematic diagram of a control strategy;

FIG. 7 is a schematic diagram of a first register queue, with (a) being queue 1, and (b) being queue 2;

FIG. 8 is a flow chart for creating the first register queue;

FIG. 9 is a schematic diagram of an analysis of a deviation of a laser vision sensor from a weld trajectory in the teaching process of the robot;

FIG. 10 is an analysis of a deviation of a weld feature point trajectory extracted and estimated by a vision system in the present invention;

FIG. 11 is a schematic diagram of a relative position and pose network in the present invention;

FIG. 12 is a schematic diagram of a working strategy for solving the issue that a deviation appears in the weld feature point trajectory extracted and estimated by a vision system in the present invention; and

FIG. 13 is a structural schematic diagram of a second register queue in the present invention, with (a) being queue 1, and (b) being queue 2.

### DETAILED DESCRIPTION

The technical solutions of the present invention are further described in detail below with reference to drawings and specific embodiments.

### 1. A Robust Weld Tracking System Guided by Active Laser Vision for the Laser-Arc Hybrid Welding of a Robot

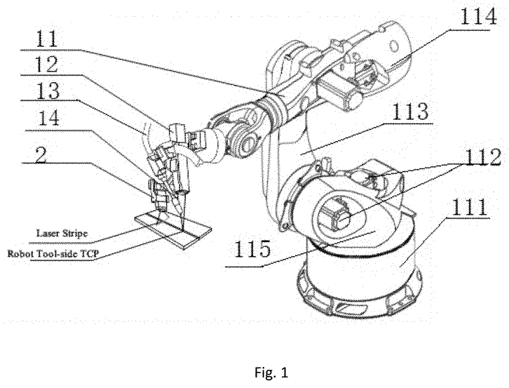

The main structure of an active laser vision weld tracking system as shown in FIG. 1 comprises a laser-arc hybrid welding robot, a laser source, an industrial camera (laser vision sensor), an image processing system, and an electrical control system.

The laser-arc hybrid welding robot employs a six-axis industrial robot 11 provided with a base 111, a robotic arm and a driving mechanism 112 therein. The robotic arm is provided with a lower arm 113 and a forearm 114, the base 111 is provided with a mount 115 for mounting the lower arm 113, a lower portion of the lower arm 113 is movably connected to the mount 115, and the forearm 114 is mounted on the top of the lower arm 113 via a movable connection. A laser- arc hybrid welding joint of the robot is mounted on the forearm 114 of the six-axis industrial robot 11. The laser-arc hybrid welding joint includes a laser welding joint 12 and an arc welding torch 14. A wire-feeding mechanism 13 is disposed on one side of the laser-arc hybrid welding joint. A welding power supply provides the integrated adjustment of welding current, arc voltage, wire feeding speed and other parameters for the laser-arc hybrid welding robot.

The laser source preferably adopts 5-30 mW blue light with a wavelength of about 450 nm; the industrial camera 2 employs a CCD camera with a resolution of 1600×1200; and the image processing system can process images that are low in quality and require no narrow-band filter.

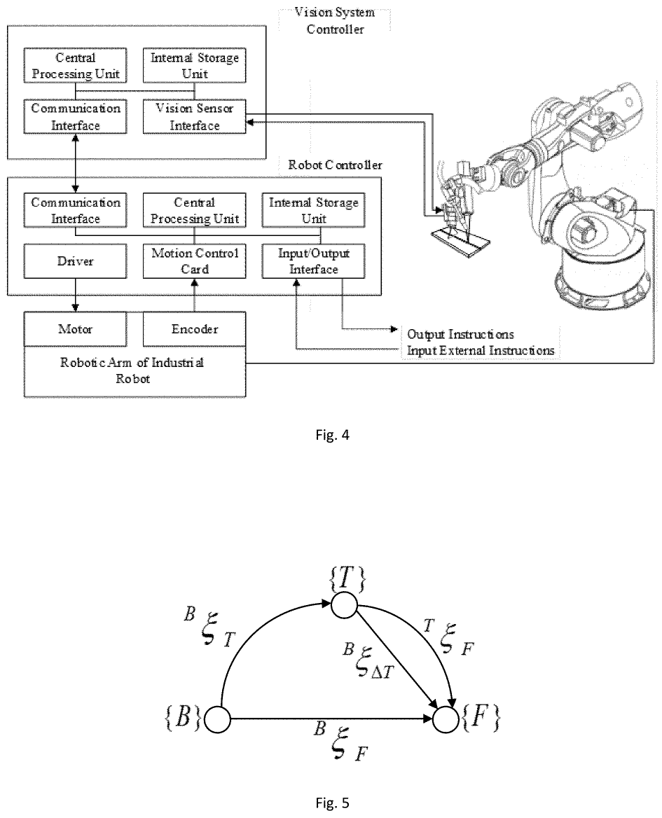

As shown in FIG. 4, the image processing system (vision system controller) is provided with a first central processing unit, a first internal storage unit, a vision sensor interface, and a first communication interface therein. The image processing system is connected to the industrial camera (laser vision sensor) via the vision sensor interface. The first internal storage unit, the vision sensor interface and the first communication interface are all connected to the first central processing unit.

The electric control system comprises a motor, an encoder, and a robot controller. The robot controller is provided with a second central processing unit, a second internal storage unit, a second communication interface, a driver, a motion control card, and an input/output interface. The input/output interface is connected to the second internal storage unit. An output end of the driver is connected to an input end of the motor for driving the robotic arm. An output end of the motor is connected to the robotic arm. The motion control card is connected to the encoder in the robotic arm. The second internal storage unit, the second communication interface, the driver, the motion control card and the input/output interface are all connected to the second central processing unit, and the robot controller is electrically connected to the image processing system via the second communication interface and the first communication interface.

### 2. Weld Image Processing and Weld Feature Point Detection and Extraction

The specific working method for performing image processing and weld position detection based on the aforementioned active laser vision weld tracking system is as follows.

A laser stripe associated with weld profile information is recognized by projecting structured light onto the surface of a weld; then an image of the laser stripe generated in the previous step is acquired by the industrial camera, and related data are sent to the image processing system; weld feature information is extracted by a data extraction module of the image processing system, and the position of the weld is detected from the central line of the laser stripe, namely, performing the deformation-free laser stripe baseline detection and the weld feature point extraction; after the position of the weld is detected from the central line of the laser stripe, the intelligent tracking of the weld is achieved with a variety of control methods, and the specific welding work is then controlled according to the tracking result.

Typically, narrow-band optical filters are used together with industrial cameras to be more sensitive and selective to light with a specific wavelength. However, the welding process is not flexible enough due to the use of these filters, which may reduce the contrast between the laser stripe and the welding white noise, as a result, extracted laser stripe position profiles may have a great deal of noise, the image preprocessing effect is poor, and in particular, the performance for feature point detection is decreased and deteriorated.

A weld image processing and weld position detection algorithm of the present invention does not need an additional narrow-band optical filter. The algorithm mainly includes two parts: (1) deformation-free laser stripe baseline detection; (2) weld feature point extraction.

### (1) Deformation-Free Laser Stripe Baseline Detection

### Step 1, Image Preprocessing

Image preprocessing is intended to remove redundant and useless objects in an image. In general, an industrial camera with a narrow-band filter is used to more sensitively and selectively allow blue laser of a certain wavelength to pass. However, the use of a filter makes the welding process less flexible, and reduces the contrast between a laser stripe and the white noise in the welding process, and as a result, it is difficult to effectively separate the white noise from the laser stripe. Mean filtering is performed to diffuse the blue laser to pixels in the surrounding neighborhood, so that high-intensity saturated pixels in the center of the laser stripe are smoother, and meanwhile, the high-intensity noise of the image background is suppressed. This mean filtering method is shown as the following formula:

$$F ( i , j ) = \frac{1}{L {W}^{2}} {\sum }_{i}^{L W} {\sum }_{j}^{L W} I ( i , j )$$

wherein LW is a desired maximum value of laser stripe width, I(i,j) is an image intensity of a pixel in the i-th row and the j-th column, and F(i,j) is a result value of filtering for the pixel the i-th row and the j-th column.

Then the processed image is converted from a RGB color space into an HSV color space, which is intended to precisely extract blue laser color from the image. Thresholds for hue, saturation and value channels are set, masking is applied to the image, and the setting of the three thresholds allows the subsequent processing for a low-contrast laser stripe generated from low-quality laser.

$${M}_{1} = \{ \begin{matrix}1 & H ( i , j ) < 0.1 \\ 1 & H ( i , j ) > 0.9 \\ 0 & otherwise\end{matrix} \\ {M}_{2} = \{ \begin{matrix}1 & S ( i , j ) > 0.2 \\ 0 & otherwise\end{matrix} \\ {M}_{3} = \{ \begin{matrix}1 & V ( i , j ) > 0.2 \\ 0 & otherwise\end{matrix} \\ M = {M}_{1} ⋂ {M}_{2} ⋂ {M}_{3}$$

wherein M₁m M₂ and M₃ are masking thresholds respectively for the hue, saturation and value channels, i and j are respectively the row number and the column number of a pixel, and M represents a masked intersection region ultimately obtained.

The original RGB image is then converted into a greyscale image by greyscale processing, and the method is as follows:

Grey=0.299*R+0.587*G+0.114*B

R, G and B in the original RGB (R, G, B) are replaced with Greys to form a new color RGB (Grey, Grey, Grey), that is, a single-channel greyscale image replacing the RGB (R, G, B) image can be formed.

The masked intersection M is applied to this single-channel greyscale image, and the median filtering is performed, wherein a sliding window containing odd points is used in the median filtering to rank the pixels in neighborhood according to grey scales, and the median is taken as an output pixel. This method can effectively suppress or remove white noise as well as salt and pepper or speckle noise generated by high-frequency laser reflection and welding arc light.

The processed image obtained from the step 1 is further used for the subsequent image processing process.

### Step 2, Detection of Laser Stripe Profile

Profile edge pixels characterizing the laser stripe are extracted by a laser peak detection method. Taking an image with a vertical laser stripe as an example, the peak pixels in each row are generally located in the laser stripe region, that is, 80% of the maximum-intensity pixel in each row is taken as the threshold, multi-peak points are extracted as the position points of the laser stripe in the image, and the rest that are less than the threshold are set to zero and will not be taken into consideration. At the same time, a filter is used to suppress the extracted objects in the horizontal direction as pseudo-noise, so that pixel intensity peak points are effectively extracted. This filtering effect reduces noise spikes at positions actually located outside the laser stripe, and thus the intensity distribution width of the laser stripe is reduced, making it easier to distinguish groups of non-noise spikes. Finally, a series of peak points are extracted.

A polynomial fitting method is adopted to fit the obtained peak points mentioned above, and the straight line returned by fitting is the detected position of the laser stripe baseline.

### (2) Extraction of Weld Feature Points

Taking the baseline obtained from the vertical laser stripe as an example, it can be known that deformed regions along the baseline can be regarded as positions containing weld feature points on the baseline. The steps of extracting these weld feature points from an image of the laser stripe can be summarized as follows: (1) determining a ROI in a vertical direction; (2) marking and selecting an intersection; (3) determining a ROI in a horizontal direction; and (4) detecting a weld (horizontal) peak point.

Around the previously obtained laser baseline, the filtered image is cropped according to the following method to determine ROIs in the vertical and horizontal directions.

The vertical ROI is obtained by the following formula:

$$ROI ( i , c ) = I ( i , j ) with$$

$$p - \frac{LW}{2} \leq j \leq p + \frac{LW}{2} ;$$

$$0 \leq i \leq N$$

wherein, LW is a desired laser stripe width, and N is the number of rows for the image; I(i,j) is an image intensity in the i-th row and the j-th column; ROI(i,c) is the region of interest of the image, and P is the column number of a laser line detected in the original image.

Then the upper top feature points and lower bottom feature points of the deformed region of the extracted laser line can be acquired.

The horizontal ROI is obtained by the following formula:

ROI(c,j)=I′(i,j)

with Yₜₒₚ≤i≤Y_{bottom}; min(Xₜₒₚ, X_{bottom})≤j≤M

wherein, Yₜₒₚ, Xₜₒₚ, Y_{bottom} and X_{bottom} are coordinate values of the upper top point and the lower bottom point in the intersection set in the image I(i,j) on the y axis and the x axis, and M is the number of columns for the image I(i,j).

The weld (horizontal) peak feature points of the deformed region of the extracted laser line can be acquired, and the method for acquiring the weld (horizontal) peak feature points is as follows:

step 1, removing noise points, and extracting profile points on the laser stripe in the horizontal ROI, namely, the feature points of the deformed region of the extracted laser stripe profile;

step 2, dividing the profile of the laser stripe in the ROI into an upper region and a lower region, and adding additional points for continuity to discontinuities in the deformed region of the laser stripe profile respectively for portions within the upper region and the lower region but outside the profile according to the following constraint condition,

−LW≤P_{ci}≤LW

wherein, LW is a desired laser stripe width, and P_{ci} is the column number of an added discontinuity;

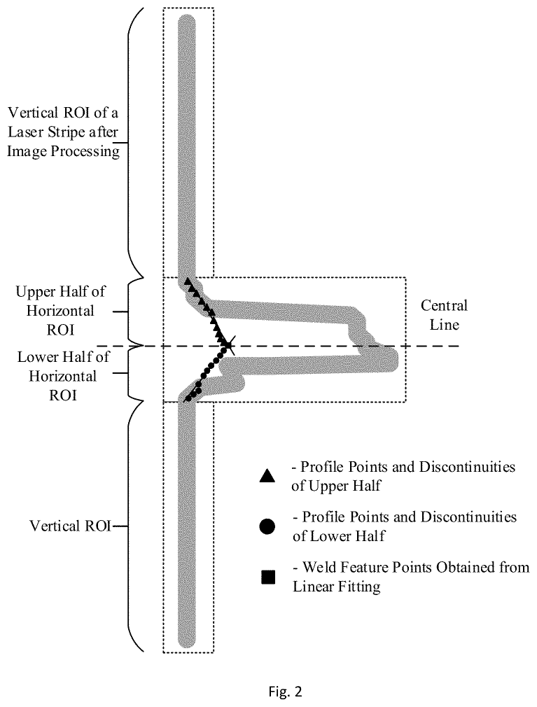

step 3, linearly fitting the profile points on the upper and lower laser stripe within the whole ROI mentioned above and the point set consisted of added discontinuities respectively, and the intersection point of the two obtained straight lines being determined as a weld peak feature point. The extraction of the weld feature points is as shown in FIG. 2.

To sum up, a top point and a bottom point within the deformed region of this laser stripe weld and the central point of the laser stripe weld can be obtained when the process of laser stripe detection and weld feature point extraction is completed through image processing.

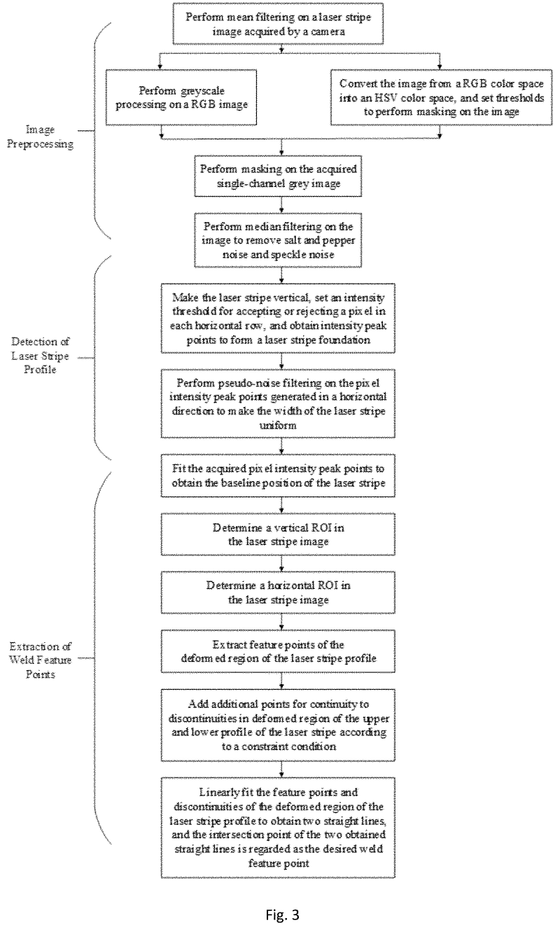

The aforementioned process of weld image processing and weld feature point detection and extraction can be summarized as FIG. 3.

In the process of weld tracking, it will be discovered that the path of the industrial robot is precise or imprecise, and when it is determined that the path of the industrial robot is precise in the tracking process, the specific working method is as follows:

a), the robot controller sends a HOME position signal, the industrial robot arrives at the initial position of the program, and the industrial robot then starts to search a start point;

b), the robot controller searches the start point of a robot tool-side TCP;

c), a first register queue is then created to record a laser vision sensor position sequence corresponding to weld feature points;

d), then it is determined whether the robot tool-side TCP is located at an initial weld feature point, if not, it will return to steps b) to c) to search the start point of the robot tool-side TCP again; and if so, a signal indicating that the robot tool-side TCP is located at the start position of the weld path is sent, and the robot controller starts an instruction for welding operation;

e), then the robot controller starts an instruction for weld tracking operation;

f), the first register queue continues to be created to record the laser vision sensor position sequence corresponding to the weld feature points;

g), the robot tool-side TCP performs the weld feature point tracking operation;

h), it is determined whether the robot tool-side TCP is located at the last weld feature point, if not, then it returns to steps f) to g) to recreate a first register queue; and if so, a signal indicating that the robot tool-side TCP is located at the last position of the weld path is sent;

and i), the robot controller ends an instruction for welding operation.

When the path of the industrial robot is found to be imprecise in the process of weld tracking, i.e. having deviations, it is required to compensate the deviations of the weld feature point trajectory, so that the robot tool-side TCP can run along a relatively precise path generated by weld feature points until a laser welding operation is completed. The specific tracking method is as follows:

a), the robot controller sends a HOME position signal, the industrial robot 11 arrives at the initial position of the program, and the industrial robot 11 then starts to search a start point;

b), the robot controller searches the start point of a robot tool-side TCP;

c), a first register queue is then created to record a laser vision sensor position sequence corresponding to weld feature points;

d), then it is determined whether the robot tool-side TCP is located at an initial weld feature point, if not, it will return to steps b) to c) to search the start point of the robot tool-side TCP again; and if so, a signal indicating that the robot tool-side TCP is located at the start position of the weld path is sent;

e), the robot controller determines whether the industrial robot 11 is dry-running;

f), if the result obtained from step e) shows that the industrial robot 11 is not dry-running, then the robot controller commands the industrial robot to continuously create a first register queue to record the laser vision sensor position sequence corresponding to the weld feature points;

g), a signal indicating that the robot tool-side TCP is located at the last position of the welding path is sent;

h), the robot controller ends an instruction for welding operation;

i), if the result obtained from step e) shows that the industrial robot 11 is dry-running, then the robot controller commands the industrial robot to create a second register queue to record the vision sensor position sequence corresponding to the weld feature points;

j), the robot controller determines whether the industrial robot 11 has completed W dry runs, and if the monitored result shows that it is not completed, then steps a) to i) are repeated;

k), if the monitored result from the previous step shows that the industrial robot 11 has completed W dry runs, then the optimal estimation for the weld feature points obtained from the W dry runs and a corresponding laser vision sensor position sequence are calculated;

l), then the robot controller commands the industrial robot 11 to start a welding operation;

m), after receiving an instruction for welding operation, the industrial robot 11 starts a welding operation;

n), the robot controller starts an instruction for weld tracking operation;

o), the robot tool-side TCP performs a tracking operation with reference to the optimal estimation for weld feature points;

p), the robot controller then determines whether the robot tool-side TCP is located at the last weld feature point, if not, then it returns to steps f) to g) to recreate a first register queue; and if so, a signal indicating that the robot tool-side TCP is located at the last position of the weld path is sent;

and q), the robot controller ends an instruction for welding operation.

### 3. A Robust Weld Tracking Algorithm

It is presumed that {T_{ref}} is a desired pose of an end effector, {T} is a coordinate system of the end effector, {F} is a target coordinate system, {C} is a coordinate system of a camera, and {B} is a base reference coordinate system of the robotic arm; P point is the aforementioned extracted central point of the laser stripe weld, and (uₚ,vₚ,1) is the image pixel coordinate of P point, denoted as Pᵤ; an intrinsic parameter matrix of the camera is Q, the transformation matrix for the coordinate system of the camera and the end coordinate system of the robotic arm is a hand-eye matrix H(^{E}_{C}T), and under the coordinate system of the camera, the plane equation for a laser plane is axₚ+byₚ+c=1.

First, according to the hand-eye matrix of the camera, a coordinate of the central weld feature point P at an image coordinate in the coordinate system of the camera is obtained, denoted as P_{c1}.

P_{c1}=Q⁻¹Pᵤ

According to the plane equation axₚ+byₚ+c=1 of the laser plane under the coordinate system of the camera, a three-dimensional coordinate of the central feature point P of the weld is obtained in the coordinate system of the camera.

P_{c}=P_{c1}/(axₚ+byₚ+c)

According to the aforementioned position and pose, based on the hand-eye matrix H (^{E}_{C}T), a coordinate of the central feature point P of the weld is obtained under the coordinate system of the end effector of the robot.

$${P}_{e} = {}_{C}^{E} T [ \begin{matrix}{P}_{c} \\ 1\end{matrix} ]$$

A coordinate of the P point under the base reference coordinate system of the robot is:

P_{b}=^{E}_{C}TPₑ

For convenience, it is denoted as ^{B}ξ_{F}.

On this basis, a robust weld tracking algorithm for a precise path of the robot and a robust weld tracking algorithm for an imprecise path of the robot are respectively proposed to solve the issue of robot tracking failure resulting from the deviation of a weld feature point trajectory in the process of teaching.

### (1), Creation of a First Register Queue

(a), After the vision sensor detects the first weld feature point, a coordinate of this feature point is denoted as ^{T}ξ_{F} relative to the coordinate system of the camera, and denoted as ^{B}ξ_{F} relative to the base reference coordinate system of the robot. Meanwhile, the position of the vision sensor along the direction of the weld when this feature point is acquired is defined as Xₛ₁ (this position is in one-to-one correspondence with the weld feature point), and in the same manner, the current position of the robot tool-side TCP at this moment is defined as Xₜ₀, and its coordinate relative to the base reference coordinate system of the robot is denoted as:

^{B}ξ_{T}=^{B}ξ_{F} [symbol] ^{T}ξ_{F}

wherein, the operator [symbol] can be regarded as generalized vector subtraction.

(b), Therefore, in order to allow the robot tool-side TCP to run from the current position Xₜ₀ to a desired point Xₜ₁, namely, a point on the position of a weld feature point detected by the vision sensor, the distance required by position compensation for the robot tool-side TCP is:

^{B}ξ_{ΔT}=^{B}ξ_{F} [symbol] ^{B}ξ_{T}

and at this moment, when the robot tool-side TCP is located at the point Xₜ₁, its coordinate in the base reference coordinate system of the robot can be denoted as:

^{B}ξ_{T}|ₜ₁=^{B}ξ_{Δt}⊕^{B}ξ_{T}|ₜ₀

wherein, the operator ⊕ can be regarded as generalized vector subtraction, and ^{B}ξ_{T}|ₜ₀ corresponds to ^{B}ξ_{T} in the above formula. FIG. 5 shows a schematic diagram of a relative position and pose network.

(c), Based on the aforementioned step, it is presumed that the queue of the position point set of the vision senor is Xₛ={Xₛ₁,Xₛ₂, . . . ,Xₛ₍ₖ₊₁₎}, and Xₛ₍ₖ₊₁₎ is a sensor end position corresponding to the last position of the weld feature points.

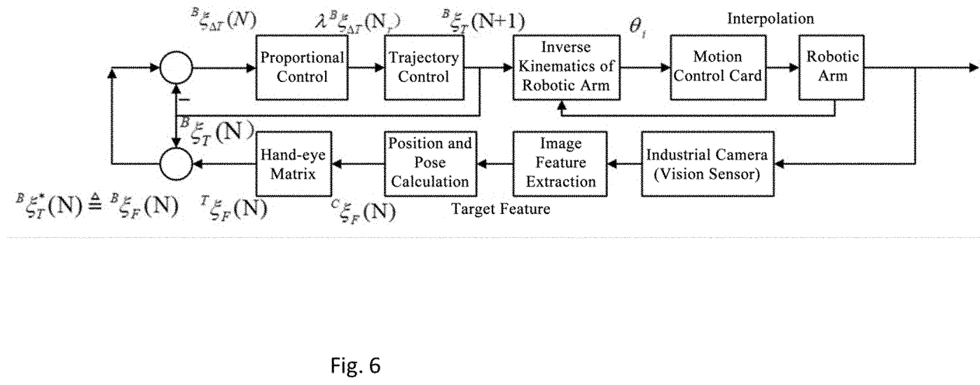

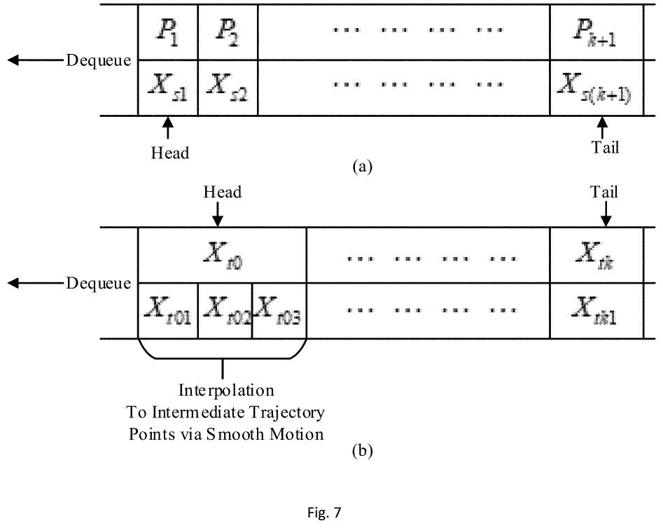

According to the control strategy shown in FIG. 6, a first register queue is formed, i.e. a vision sensor position point queue in one-to-one correspondence with the weld feature points, as shown in FIG. 7.

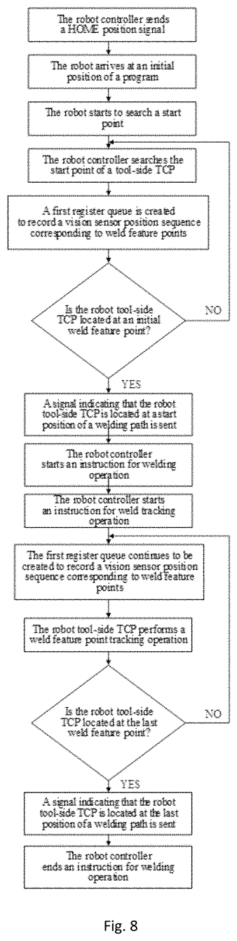

Among the two queues in FIG. 7, (a) is queue 1, including weld feature points P₁, P₂ . . . Pₖ₊₁ in one-to-one correspondence with positions Xₛ₁, Xₛ₂ . . . Xₛ₍ₖ₊₁₎ of a vision sensor along the direction of a weld; (b) is queue 2, including positions Xₜ₀, Xₜ₁ . . . Xₜₖ of the robot tool-side TCP along the direction of a weld. According to the aforementioned control strategy for a robotic arm, either by rotational joints or in a spatial coordinate movement manner, interpolation is performed between the adjacent sequential position points of the tool-side TCP of the robotic arm to ensure that the robotic arm smoothly moves to intermediate trajectory points, thus achieving a desired position and pose. The flow of the aforementioned process is shown as FIG. 8.

In addition, on the basis that jogging teaching is very accurate, that is, the operator ensures that the robot tool-side TCP is kept consistent with the central line of the weld during the whole teaching process of the robot, and meanwhile ensures that the vision sensor or the whole vision system is located at a fixed position in a vertical direction over the weld feature points during the whole teaching process, the aforementioned weld tracking method can be effectively applied in the laser welding process of the robot.

### (2), Creation of a Second Register Queue

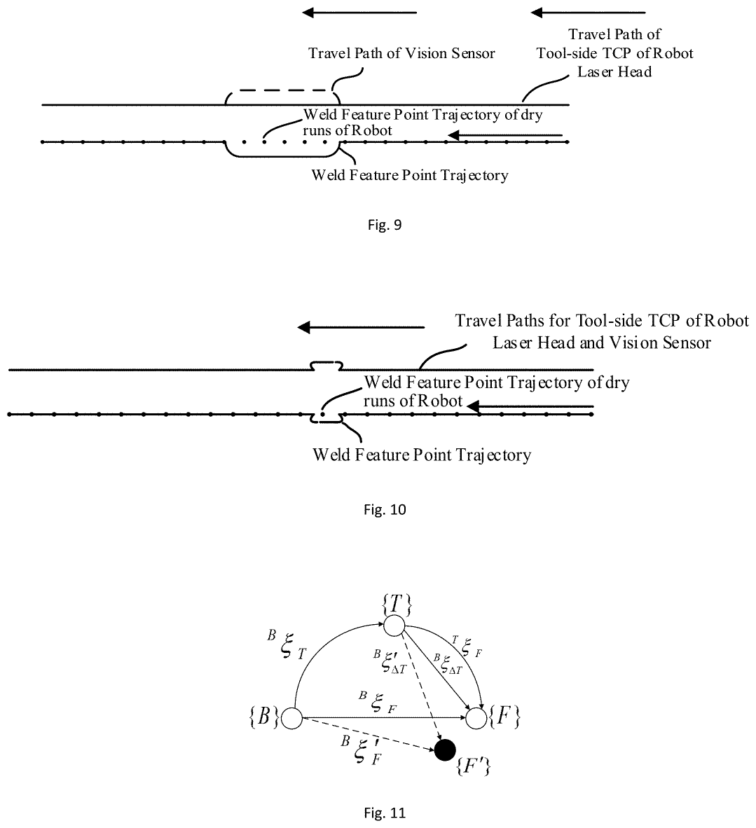

Although an operator ensures that the robot tool-side TCP is always at the central line of a weld during the process of jogging teaching, it is difficult to avoid the situation where the vision sensor deviates from a weld trajectory during the teaching process of a robot, as shown in FIG. 9.

In FIG. 9, in the process of jogging teaching, the travel path of the vision sensor has a small deviation, while the robot tool-side TCP travels strictly along the central line of the weld. As a result, a weld feature point trajectory extracted and estimated by the vision system has a deviation, which will lead to a certain deviation when the weld tracking method of the first register queue mentioned above is applied, and thus jeopardizes the tracking precision and accuracy.

In FIG. 10, in the process of jogging teaching, the robot tool-side TCP may deviate from the weld path due to human factors, which will also lead to deviation of the weld feature point trajectory extracted and estimated by the vision system, and when a subsequent weld tracking is conducted on this basis, the robot tool-side TCP may deviate from the weld path, thereby resulting in welding failure.

In order to solve the aforementioned problems, it is required to compensate the deviations of the weld feature point trajectory occurred in the above two situations, so that the robot tool-side TCP can run along a relatively precise path generated by weld feature points to effectively carry out the laser welding operation.

In the process of jogging teaching by an operator, a deviation of the weld feature point trajectory caused by either a deviation of the visual sensor or a deviation of the position and pose for the motion of the robot itself will influence the effect of a subsequent automatic weld tracking. Therefore, the aforementioned deviation should be compensated. The premise is that a precise and reliable trajectory generated by a weld feature point sequence is required for weld tracking of the robot.

(a), In order to obtain a desired weld feature point sequence as a reference, first, teaching programming is performed for the robot with regard to this weld and it is ensured that the robot tool-side TCP keeps running on the central line of the weld, so that a robot tool-side TCP trajectory program which is relatively reliable when it is running at a normal welding operation speed is obtained.

(b), On the basis of ensuring that the position and pose of the vision sensor are correctly fixed, a weld feature point sequence is extracted and a position point sequence of the vision sensor along the direction of a weld is determined in accordance with a “first register queue” method, the weld feature point sequence are in one-to-one correspondence with the position point sequence, and the latter is denoted as X_{sd}={X_{sd1},X_{sd2}, . . . ,X_{sd(l+1)}}; and meanwhile, the position X_{td}={X_{td0},X_{td2}, . . . ,X_{tdl}} of the robot tool-side TCP along the direction of a weld is recorded, and in this case, the position compensation for the robot tool-side TCP and the subsequent tracking operation for weld feature points are not performed.

The robot performs the aforementioned W dry runs, and at the position points of the vision sensor, the coordinate sequence of the weld feature points relative to the base reference coordinate system of the robot is denoted as:

^{B}ξ_{F}ⁱ|_{sd}={^{B}ξ_{F}ⁱ|_{sd1}, ^{B}ξ_{F}ⁱ|_{sd2}, . . . , ^{B}ξ_{F}ⁱ|_{sd(l+1)}} (i∈{1,2, . . . ,W})

On this basis, the coordinate values of the weld feature points corresponding to the position points of the vision sensor are optimally estimated to reject the coordinate values of the weld feature points that have great deviations, so that a “weld feature point trajectory of the dry runs of the robot” as shown in FIG. 10 can be obtained as a desired reference value for the tracking of the robot tool-side TCP, denoted as

^{B}\hat{ξ}_{F}|_{sd}={^{B}\hat{ξ}_{F}|_{sd1}, ^{B}\hat{ξ}_{F}|_{sd2}, . . . , ^{B}\hat{ξ}_{F}|_{sd(l+1)}}

and ^{B}\hat{ξ}_{F}|_{sd}=^{B}ξ′_{F}|_{sd} corresponding to X_{sd}, and having the relationship shown in FIG. 11.

By reference to the coordinates of the weld feature points obtained from the dry runs, the robot tool-side TCP can get out of the misguidance of the deviating points and compensate the deviations caused by diverging, and thus correctly travel along the central line of the weld.

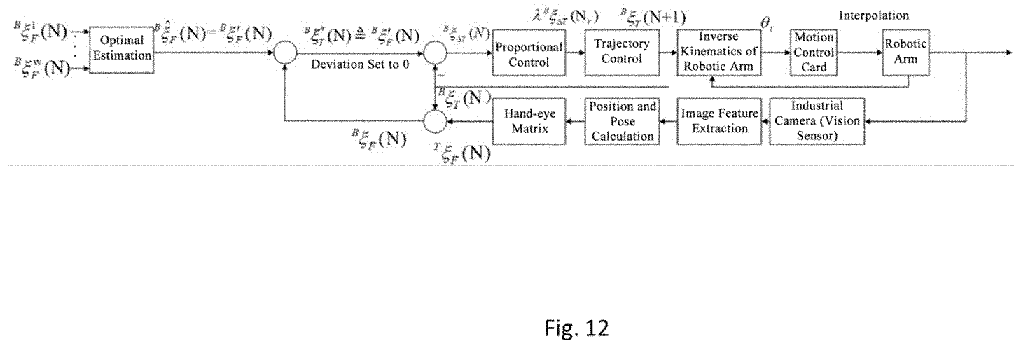

(c), According to the above steps, the desired control strategy for the automatic tracking of the robot tool-side TCP according to the weld feature point positions obtained from the dry runs is shown as FIG. 12.

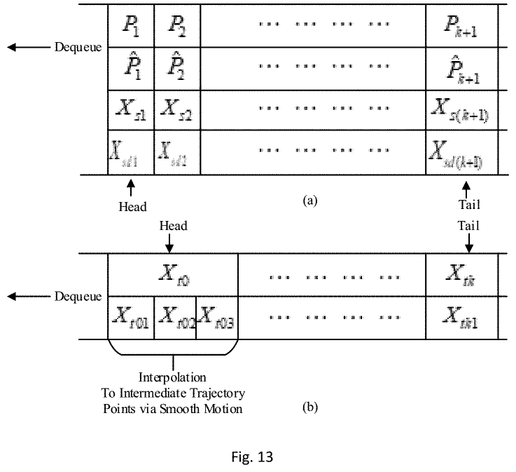

According to the control strategy shown in FIG. 12, a second register queue is formed, i.e. a vision sensor position point queue in one-to-one correspondence with the weld feature points and a position point queue of the robot tool-side TCP along the direction of a weld in the tracking process, as shown in FIG. 13.

(a) is queue 1, including weld feature points P₁, P₂ . . . Pₖ₊₁ in one-to-one correspondence with positions Xₛ₁, Xₛ₂ . . . Xₛ₍ₖ₊₁₎ of the vision sensor along the direction of a weld and reference weld feature points \hat{P}₁, \hat{P}₂ . . . \hat{P}ₖ₊₁ obtained from multiple dry runs in one-to-one correspondence with positions X_{sd1}, X_{sd2} . . . X_{sd(k+1)} of the vision sensor during the dry runs. (b) is queue 2, including positions to Xₜ₀, Xₜ₁ . . . Xₜₖ of the robot tool-side TCP along the direction of a weld. According to the aforementioned control strategy for the robotic arm, either by rotational joints or in a spatial coordinate movement manner, interpolation will be performed between the adjacent sequential position points of the tool-side TCP of the robotic arm to ensure that the robotic arm smoothly moves to intermediate trajectory points, thus achieving a desired position and pose.

What is claimed is:

1. An active laser vision weld tracking system, comprising:
an industrial robot comprising a base, a robotic arm, and a driving mechanism, wherein the robotic arm comprises a lower arm and a forearm, the base is provided with a mount for mounting the lower arm, a lower portion of the lower arm is movably connected to the mount, the forearm is mounted on the top of the lower arm via a movable connection, and the forearm of the industrial robot is provided with a laser-arc hybrid welding joint having a wire-feeding mechanism on one side thereof;
an active laser vision system comprising a laser source, a laser vision sensor for recognizing a laser stripe, and an image processing system for extracting weld feature information and detecting the position of a weld, wherein the image processing system is electrically connected to the laser vision sensor; and
an electrical control system comprising a robot controller configured to control the actions of the industrial robot and the robotic arm thereof,
wherein there is a two-way communication connection between the image processing system and the robot controller.

2. The active laser vision weld tracking system according to claim 1, wherein the image processing system comprises a first central processing unit, a first internal storage unit, a vision sensor interface, and a first communication interface; and the laser vision sensor is in two-way communication with each unit in the image processing system via the vision sensor interface.

3. The active laser vision weld tracking system according to claim 1, wherein the robot controller comprises a second central processing unit, a second internal storage unit, a second communication interface, a driver, a motion control card, and an input/output interface, wherein the input/output interface is configured to input and output instructions, the driver is connected to a motor of the robotic arm, and the motion control card is connected to an encoder of the robotic arm.

4. The active laser vision weld tracking system according to claim 1, wherein an industrial camera is adopted as the laser vision sensor.

5. A weld position detection method based on the active laser vision weld tracking system according to any one of claims 1 to 4, comprising the following steps:
step 1, recognizing, by the laser vision sensor, a laser stripe associated with weld profile information through projecting structured light onto the surface of a weld;
step 2, extracting weld feature information by using an image processing method, and detecting the position of the weld from the central line of the laser stripe;
step 3, performing the intelligent tracking on the weld, and determining whether a weld tracking path of the industrial robot is precise;
and step 4, controlling a welding operation of the robot according to an intelligent weld tracking result.

6. The weld position detection method according to claim 5, wherein the step 2 specifically comprises:
2.1, image preprocessing:
a, performing mean filtering on a laser stripe image acquired by the laser vision sensor:
$$F ( i , j ) = \frac{1}{L {W}^{2}} {\sum }_{i}^{L W} {\sum }_{j}^{L W} I ( i , j )$$
wherein, LW is a desired laser stripe width, I(i,j) is an image intensity of a pixel in the i-th row and the j-th column, and F(i,j) is a result value of filtering for the pixel in the i-th row and the j-th column;
b, converting the processed image from a RGB color space into an HSV color space, setting thresholds for hue, saturation and value channels, and applying masking to the image:
$${M}_{1} = \{ \begin{matrix}1 & H ( i , j ) < 0.1 \\ 1 & H ( i , j ) > 0.9 \\ 0 & otherwise\end{matrix} \\ {M}_{2} = \{ \begin{matrix}1 & S ( i , j ) > 0.2 \\ 0 & otherwise\end{matrix} \\ {M}_{3} = \{ \begin{matrix}1 & V ( i , j ) > 0.2 \\ 0 & otherwise\end{matrix} \\ M = {M}_{1} ⋂ {M}_{2} ⋂ {M}_{3}$$
wherein, M₁, M₂ and M₃ are masking thresholds respectively for the hue, saturation and value channels, i and j are respectively the row number and the column number of a pixel, and M represents a masked intersection region ultimately obtained;
c, converting the original RGB image into a greyscale image by greyscale processing:
Grey=0.299*R+0.587*G+0.114*B
wherein R, G and B in the original RGB (R, G, B) are replaced with Greys to form a new color RGB (Grey, Grey, Grey), thereby forming a single-channel greyscale image that replaces the RGB (R, G, B) image, and the masked intersection is applied to this single-channel greyscale image;
d, performing median filtering on the image to remove salt and pepper noise and speckle noise;
2.2, detection of laser stripe profile:
a, extracting profile edge pixels characterizing the laser stripe by a laser peak detection method;
b, performing noise filtering on the pixel intensity peak points generated in a horizontal direction, and fitting the acquired pixel intensity peak points to obtain the baseline position of the laser stripe;
2.3, extraction of weld feature points:
a, determining a ROI in a vertical direction:
$$ROI ( i , c ) = I ( i , j ) with$$
$$p - \frac{LW}{2} \leq j \leq p + \frac{LW}{2} ;$$
$$0 \leq i \leq N$$
wherein, LW is a desired laser stripe width, N is the number of rows for the image, I(i,j) is an image intensity in the i-th row and the j-th column, ROI(i,c) is a region of interest in the image, and P is the column number of a laser line detected in the original image;
and wherein the upper top feature points and lower bottom feature points of the deformed region of the extracted laser line are acquired;
b, marking and selecting an intersection;
c, determining a ROI in a horizontal direction:
ROI(c,j)=I′(i,j)
with Yₜₒₚ≤i≤Y_{bottom}; min(Xₜₒₚ, X_{bottom})≤j≤M
wherein, Yₜₒₚ, Xₜₒₚ, Y_{bottom} and X_{bottom} are coordinate values of the upper top point and the lower bottom point in the intersection set in the image I(i,j) on the y axis and the x axis, and M is the number of columns for the image I(i,j);
and d, acquiring a horizontal peak feature point of the weld:
d1, removing noise points, and extracting profile points on the laser stripe in the horizontal ROI;
d2, dividing the profile of the laser stripe in the ROI into an upper region and a lower region, and adding additional points for continuity to discontinuities in the deformed region of the laser stripe profile respectively for portions within the upper region and the lower region but outside the profile according to the following constraint condition;
−LW≤P_{ci}≤LW
wherein, LW is a desired laser stripe width, and P_{ci} is the column number of an added discontinuity;
d3, linearly fitting the profile points on the upper and lower laser stripe within the whole ROI mentioned above and the point set consisted of added discontinuities respectively, and the intersection point of the two obtained straight lines being a weld peak feature point;
and obtaining a top point and a bottom point within the deformed region of this laser stripe weld and the central point of the laser stripe weld when the process of laser stripe detection and weld feature point extraction is completed through image processing.

7. The weld position detection method according to claim 5, wherein in the step 3, when it is determined that the weld tracking path of the industrial robot is precise:
1.1, the robot controller sends a HOME position signal, and the industrial robot searches a start point;
1.2, the robot controller searches the start point of a robot tool-side TCP;
1.3, a first register queue is created to record a laser vision sensor position sequence corresponding to weld feature points;
1.4, it is determined whether the robot tool-side TCP is located at an initial weld feature point, if not, it returns to steps 1.2 to 1.3 to search the start point of the robot tool-side TCP again; and if so, a signal indicating that the robot tool-side TCP is located at the start position of the weld path is sent, and the robot controller starts an instruction for welding operation;
1.5, then the robot controller starts an instruction for weld tracking operation;
1.6, the first register queue continues to be created to record the laser vision sensor position sequence corresponding to the weld feature points;
1.7, the robot tool-side TCP performs the weld feature point tracking operation;
1.8, it is determined whether the robot tool-side TCP is located at the last weld feature point, if not, then it returns to steps 1.6 to 1.7 to recreate a first register queue; and if so, a signal indicating that the robot tool-side TCP is located at the last position of the weld path is sent;
1.9, the robot controller ends an instruction for welding operation.

8. The weld position detection method according to claim 5, wherein in the step 3, when a deviation is found in the weld tracking path of the industrial robot, the deviation of the weld feature point trajectory is compensated, and the specific steps are as follows:
2.1, the robot controller sends a HOME position signal, and the industrial robot searches a start point;
2.2, the robot controller searches the start point of a robot tool-side TCP;
2.3, a first register queue is created to record a laser vision sensor position sequence corresponding to weld feature points;
2.4, it is determined whether the robot tool-side TCP is located at an initial weld feature point, if not, it returns to steps 2.2 to 2.3 to search the start point of the robot tool-side TCP again; and if so, a signal indicating that the robot tool-side TCP is located at the start position of the weld path is sent;
2.5, the robot controller determines whether the industrial robot is dry-running;
2.6, if the industrial robot is not dry-running, then the robot controller commands the industrial robot to continuously create the first register queue to record the laser vision sensor position sequence corresponding to the weld feature points;
2.7, a signal indicating that the robot tool-side TCP is located at the last position of the welding path is sent;
2.8, the robot controller ends an instruction for welding operation;
2.9, if the industrial robot is dry-running, then the robot controller commands the industrial robot to create a second register queue to record the vision sensor position sequence corresponding to the weld feature points;
2.10, the robot controller determines whether the industrial robot has completed W dry runs, and if the monitored result shows that it is not completed, then steps 2.1 to 2.9 are repeated;
2.11, if the industrial robot has completed W dry runs, then the optimal estimation for the weld feature points obtained from the W dry runs and a corresponding laser vision sensor position sequence are calculated;
2.12, the robot controller commands the industrial robot to start a welding operation;
2.13, after receiving an instruction for welding operation, the industrial robot starts a welding operation;
2.14, the robot controller starts an instruction for weld tracking operation;
2.15, the robot tool-side TCP performs a tracking operation with reference to the optimal estimation for weld feature points;
2.16, the robot controller determines whether the robot tool-side TCP is located at the last weld feature point, if not, then it returns to steps 2.6 to 2.7 to recreate a first register queue; and if so, a signal indicating that the robot tool-side TCP is located at the last position of the weld path is sent;
2.17, the robot controller ends an instruction for welding operation.

9. A robust weld tracking algorithm based on the weld position detection method according to claim 5, comprising the following contents:
presuming that {T_{ref}} is a desired pose of an end effector, {T} is a coordinate system of the end effector, {F} is a target coordinate system, {C} is a coordinate system of a camera, {B} is a base reference coordinate system of the robotic arm, P is a central point of a laser stripe weld, and (uₚ,vₚ,1)^{T} is the image pixel coordinate for the P point, denoted as Pᵤ; and an intrinsic parameter matrix of the camera is Q, the transformation matrix for the coordinate system of the camera and the end coordinate system of the robotic arm is a hand-eye matrix H(^{E}_{C}T), and under the coordinate system of the camera, the plane equation for a laser plane is axₚ+byₚ+c=1;
first, according to the hand-eye matrix of the camera, obtaining a coordinate of the central weld feature point P at an image coordinate in the coordinate system of the camera, denoted as P_{c1};
P_{c1}=Q⁻¹Pᵤ
according to the plane equation axₚ+byₚ+c=1 of the laser plane under the coordinate system of the camera, obtaining a three-dimensional coordinate of the central weld feature point P in the coordinate system of the camera;
P_{c}=P_{c1}/(axₚ+byₚ+c)
according to the aforementioned position and pose, based on the hand-eye matrix H(^{E}_{C}T), obtaining a coordinate of the central weld feature point P under the coordinate system of the end effector of the robot;
$${P}_{e} = {}_{C}^{E} T [ \begin{matrix}{P}_{c} \\ 1\end{matrix} ]$$
a coordinate of the P point under the base reference coordinate system of the robot being:
P_{b}=^{E}_{C}TPₑ
denoted as ^{B}ξ_{F};
(1), creation of a first register queue
(a), after the vision sensor detects the first weld feature point, denoting a coordinate of this feature point as ^{T}ξ_{F} relative to the coordinate system of the camera, and as ^{B}ξ_{F} relative to the base reference coordinate system of the robot; meanwhile, defining the position of the vision sensor along the direction of the weld when this feature point is acquired as Xₛ₁, this position being in one-to-one correspondence with the weld feature point; and likewise, defining the current position of the robot tool-side TCP at this moment as Xₜ₀, and denoting a coordinate of the robot tool-side TCP relative to the base reference coordinate system of the robot as:
^{B}ξ_{T}=^{B}ξ_{F} [symbol] ^{T}ξ_{F}
wherein, the operator [symbol] is generalized vector subtraction;
(b), therefore, in order to allow the robot tool-side TCP to run from the current position Xₜ₀ to a desired point Xₜ₁, namely, a point on the position of a weld feature point detected by the vision sensor, the distance required by position compensation for the robot tool-side TCP being:
^{B}ξ_{ΔT}=^{B}ξ_{F} [symbol] ^{B}ξ_{T}
and at this moment, when the robot tool-side TCP is located at the point Xₜ₁, denoting a coordinate of the robot tool-side TCP in the base reference coordinate system of the robot as:
^{B}ξ_{T}|ₜ₁=^{B}ξ_{Δt}⊕^{B}ξ_{T}|ₜ₀
wherein, the operator ⊕ is generalized vector addition; and ^{B}ξ_{T}|ₜ₀ corresponds to ^{B}ξ_{T} in the above formula;
and (c), based on the aforementioned step, presuming that the queue of the position point set of the vision senor is Xₛ={Xₛ₁,Xₛ₂, . . . ,Xₛ₍ₖ₊₁₎}, and Xₛ₍ₖ₊₁₎ is a sensor end position corresponding to the last position of the weld feature points;
forming two queues, namely, vision sensor position point queues in one-to-one correspondence with the weld feature points, wherein queue 1 includes weld feature points P₁, P₂ . . . Pₖ₊₁, which are in one-to-one correspondence with positions Xₛ₁, Xₛ₂ . . . Xₛ₍ₖ₊₁₎ of the vision sensor along the direction of a weld, and queue 2 includes positions Xₜ₀, Xₜ₁ . . . Xₜₖ of the robot tool-side TCP along the direction of a weld; and according to the aforementioned control strategy for the robotic arm, either by rotational joints or in a spatial coordinate movement manner, performing interpolation between the adjacent sequential position points of the tool-side TCP of the robotic arm to ensure that the robotic arm smoothly moves to intermediate trajectory points, thus achieving a desired position and pose;
(2), creation of a second register queue
(a), first, performing teaching programming for the robot with regard to this weld, and making sure that the robot tool-side TCP keeps running on the central line of the weld, so that a robot tool-side TCP trajectory program which is relatively reliable when it is running at a normal welding operation speed is obtained;
(b), on the basis of ensuring that the position and pose of the vision sensor are correctly fixed, extracting a weld feature point sequence and determining a position point sequence of the vision sensor along the direction of a weld in accordance with a “first register queue” method, and denoting the latter as X_{sd}={X_{sd1},X_{sd2}, . . . ,X_{sd(l+1)}}; meanwhile, recording the position X_{td}={X_{td0},X_{td2}, . . . ,X_{tdl}} of the robot tool-side TCP along the direction of the weld, and in this case, not performing the position compensation for the robot tool-side TCP and the subsequent tracking operation for the weld feature points;
the robot performing the aforementioned W dry runs, and at the position points of the vision sensor, the coordinate sequence of the weld feature points relative to the base reference coordinate system of the robot being denoted as:
^{B}ξ_{F}ⁱ|_{sd}={^{B}ξ_{F}ⁱ|_{sd1}, ^{B}ξ_{F}ⁱ|_{sd2}, . . . , ^{B}ξ_{F}ⁱ|_{sd(l+1)}} (i∈{1,2, . . . ,W})
on this basis, optimally estimating the coordinate values of the weld feature points corresponding to the position points of the vision sensor to reject coordinate values of the weld feature points that have great deviations, so that a weld feature point trajectory of the dry runs of the robot is obtained as a desired reference value for the tracking of the robot tool-side TCP, denoted as
^{B}\hat{ξ}_{F}|_{sd}={^{B}\hat{ξ}_{F}|_{sd1}, ^{B}\hat{ξ}_{F}|_{sd2}, . . . , ^{B}\hat{ξ}_{F}|_{sd(l+1)}}
and ^{B}\hat{ξ}_{F}|_{sd}=^{B}ξ′_{F}|_{sd} corresponding to X_{sd};
and by reference to the coordinates of the weld feature points obtained from the dry runs, the robot tool-side TCP getting out of the misguidance of the deviating points, compensating the deviations caused by diverging, and thus correctly traveling along the central line of the weld;
(c), based on the aforementioned step, forming two queues according to the positions of the weld feature points obtained from the dry runs as a desired control strategy for automatic tracking by the robot tool-side TCP, namely, a vision sensor position point queue in one-to-one correspondence with the weld feature points and a position point queue along the direction of the weld during the tracking process by the robot tool-side TCP, wherein queue 1 includes weld feature points P₁, P₂ . . . Pₖ₊₁ in one-to-one correspondence with positions Xₛ₁, Xₛ₂ . . . Xₛ₍ₖ₊₁₎ of the vision sensor along the direction of the weld and reference weld feature points \hat{P}₁, \hat{P}₂ . . . \hat{P}ₖ₊₁ obtained from multiple dry runs in one-to-one correspondence with positions X_{sd1}, X_{sd2} . . . X_{sd(k+1)} of the vision sensor during the dry runs, and queue 2 includes positions Xₜ₀, Xₜ₁ . . . Xₜₖ of the robot tool-side TCP along the direction of the weld; and according to the aforementioned control strategy for the robotic arm, either by rotational joints or in a spatial coordinate movement manner, performing interpolation between the adjacent sequential position points of the tool-side TCP of the robotic arm to ensure that the robotic arm smoothly moves to intermediate trajectory points, thus achieving a desired position and pose.
